(19) United States
(12) Patent Application Publication
(10) Pub. No.: US 2008/0228509 A1
(43) Pub. Date: Sep. 18, 2008

(54) Systems and/or methods for incentivizing agent-based decision-making

(76) Inventor: Ryan Weber, Arlington, VA (US)

Correspondence Address: NIXON & VANDERHYE, PC, 901 NORTH GLEBE ROAD, 11TH FLOOR, ARLINGTON, VA, 22203, US

(21) Appl. No.: 11/724,249

(22) Filed: Mar. 15, 2007

(51) Int. Cl. G06Q 10/00

(52) U.S. Cl. 705/1

(57) ABSTRACT

Systems and/or methods that encourage an agent to become a true agent of a principal by rewarding or penalizing an agent for exceeding or falling below a benchmark for a specific transaction set by, or on behalf of, the principal are provided. In certain exemplary embodiments, a benchmark for each purchasable good and/or service in a plurality of purchasable goods and/or services may be calculated. Information about a good and/or service to be purchased may be compared to a relevant benchmark. The agent may be rewarded based on the result of the comparing step. The benchmark may be weighted based on parameters input by the principal, including, for example price, durability, quality, performance, and/or other preferences. A database of benchmarks may be maintained and/or updated periodically automatically, by the principal, and/or by an independent third-party.

### FIELD OF THE INVENTION

The exemplary embodiments described herein relate to systems and/or methods for incentivizing agent-based decision-making and, more particularly, to systems and/or methods that encourage an agent to become a true agent of a principal by rewarding or penalizing an agent for exceeding or falling below a benchmark for a specific transaction set by, or on behalf of, the principal.

### BACKGROUND AND SUMMARY OF THE INVENTION

Principals frequently hire agents to perform tasks on their behalves. Examples of principal-agent relationships include, for example, employer-employee, buyer/seller and real estate agent, client-lawyer, and government-contractor. An agent typically will have information unknown and/or unavailable to the principal, and will use this information to make decisions and/or act for the principal.

Unfortunately, however, a self-interested agent may not necessary make the same decisions and/or take the same actions as a self-interested principal. In other words, an agent acting in its own best interest may make decisions and/or take actions that are not aligned with the best interests of the principal, thus undermining a basic assumption of the principal-agent relationship.

The collection of difficulties that arise under conditions of incomplete and/or asymmetric information when a principal retains an agent is sometimes referred to as the principal-agent problem. FIG. 1 is a conceptualized view of an exemplary task that helps to demonstrate the nature and character of the principal-agent problem. More particularly, FIG. 1 shows two scenarios involving the purchase of a single widget from a choice from among three widgets. In both scenarios, the principal P pays the primary costs and receives the primary benefits. In Scenario 1, the principal P is tasked with selecting the widget directly. Accordingly, the principal P picks widget 1 because it has the lowest cost and the highest value.

However, in Scenario 2, the principal P hires an agent A, and then tasks the agent A with purchasing the widget. This may result in the agent A selecting widget 2 for any number of reasons (e.g., this was the first widget the agent found when searching for widgets, it was the easiest to procure, etc.). Yet, this result is worse for the principal than if the principal had selected the widget itself, as in Scenario 1, but no different for the agent. That is, the result for the agent is the same as when the agent did not make the decision at all. This is true even though the principal is now comparatively worse-off than under Scenario 1.

A partial explanation for this disparity between the results of Scenarios 1 and 2 in is that when the person making the decision receives all of the benefits and bears all of the costs, that generally person will make the most economically rational decision. Even when the computations are modestly complicated (e.g., with the introduction of rewards and cash back programs and the consideration of time/energy and convenience), this principle still may hold. The idea of maximizing benefits and minimizing costs is a part of microeconomic theory generally, and price theory more particularly.

Table 1 shows a slightly more complicated version of Scenario 1 described above with reference to FIG. 1. Because widget 1 confers the greatest net benefit, the principal will prefer and pick this widget at least when the principal is acting rationally, as described above.

TABLE 1

| | Benefits for Principal | Costs for Principal | Net |
|---|---|---|---|
| W1 | Primary Benefit: $25 in value | Primary Cost: $10 direct cost | $25.60 |
| | Secondary Benefits: | Secondary Costs: | −10.50 |
| | Vendor Specific Rewards Program A: | Time/Energy: Most = $0.25 | $15.10 |
| | 5% of purchase = $0.50 | Convenience: Least = $0.25 | |
| | Cash Back Program: | | |
| | 1% cash back = $0.10 | | |
| W2 | Primary Benefit: $25 in value | Primary Cost: $15 direct cost | $26.65 |
| | Secondary Benefits: | Secondary Costs: | −15.20 |
| | Vendor Specific Rewards Program B: | Time/Energy: Least = $0.10 | $11.45 |
| | 5% of purchase = $1.50 | Convenience: Most = $0.10 | |
| | Cash Back Program: | | |
| | 1% cash back = $0.15 | | |
| W3 | Primary Benefit: $25 in value | Primary Cost: $20 direct cost | $26.20 |
| | Secondary Benefits: | Secondary Costs: | −20.35 |
| | Vendor Specific Rewards Program C: | Time/Energy: Most = $0.25 | $5.85 |
| | 5% of purchase = $1.00 | Convenience: Most = $0.10 | |
| | Cash Back Program: | | |
| | 1% cash back = $0.20 | | |

However, when all of the costs and benefits are not reasonably distributed, the most rational decision for the agent may not end in the best outcome for the principal. Tables 2a and 2b represent the division of Table 1 into benefits and costs for the principal and agent, this time based on Scenario 2 described above with reference to FIG. 1. As Tables 2a and 2b indicate, although the principal still prefers (and thus would have picked) widget 1, the agent prefers and picks widget 2, thereby making a suboptimal decision from the principal's perspective but an comparatively advantageous decision from the agent's perspective.

TABLE 2a

| | Benefits for Principal | Costs for Principal | Net |
|---|---|---|---|
| W1 | Primary Benefit: | Primary Cost: | $25.00 |
| | $25 in value | $10 direct cost | |
| | | | −10.00 |
| | | | $15.00 |
| W2 | Primary Benefit: | Primary Cost: | $25.00 |
| | $25 in value | $15 direct cost | |
| | | | −15.00 |
| | | | $10.00 |
| W3 | Primary Benefit: | Primary Cost: | $25.00 |
| | $25 in value | $20 direct cost | |
| | | | −20.00 |
| | | | $5.00 |

TABLE 2b

| | Benefits for Agent | Costs for Agent | Net |
|---|---|---|---|
| W1 | Program A: 5% of | Time/Energy: Most = $0.25 | $0.60 |
| | purchase = $0.50 | | |
| | Cash Back: 1% cash | Convenience: Least = $0.25 | −.50 |
| | back = $0.10 | | |
| | | | $0.10 |
| W2 | Program B: 5% of | Time/Energy: Least = $0.10 | $1.65 |
| | purchase = $1.50 | | |
| | Cash Back: 1% cash | Convenience: Most = $0.10 | −.20 |
| | back = $0.15 | | |
| | | | $1.45 |
| W3 | Program A: 5% of | Time/Energy: Most = $0.25 | $1.20 |
| | purchase = $1 | | |
| | Cash Back: 1% cash | Convenience: Most = $0.10 | −.35 |
| | back = $0.20 | | |
| | | | $0.85 |

These scenarios show widgets of variable costs but of equal value to the principal. These conditions, computations, and decisions can become much more complicated when both the costs and benefits are variable and/or are not readily known to the principal and/or agent.

There are several possible solutions that would reduce the problems posed by agents undertaking transactions on behalf of their principals. For example, principals simply could avoid hiring agents completely. However, it will be appreciated that this solution is not practical and is not scalable. A large business owner, for example, cannot be expected to make all decisions directly, and there is thus a need to hire others and to delegate decisions. Another solution relates to conducting periodic audits of agent decisions to confirm compliance. Although this strategy may improve agent compliance, verifying that an agent always makes the best decision can be expensive (e.g., in terms of time, money, and resources) and/or overly intrusive. Accordingly, this solution tends to be impractical and not scalable, as well.

Thus, it will be appreciated that there is a need in the art for techniques for incentivizing agent-based decision-making by devising an incentive scheme to align agent behavior with the best interests of the principal the agent serves.

One aspect of certain exemplary embodiments of this invention relates to a benchmark-driven incentive scheme for agent-based decision-making.

Another aspect of certain exemplary embodiments relates to techniques for incentivizing agent-based decision-making.

Still another aspect of certain exemplary embodiments relates to techniques for generating a good- and/or service-specific benchmark based on a relevant data.

Yet another aspect of certain exemplary embodiments relates to rewarding or penalizing an agent for beating or failing to exceeding the benchmark.

According to certain exemplary embodiments, a system for aligning the interests of a principal and an agent serving the principal is provided. Product information gathering programmed logic circuitry may gather from a plurality of vendors information about a good and/or service for sale by each said vendor. Benchmark calculating programmed logic circuitry may calculate a benchmark for each good and/or service based at least on the information gathered by the product information gathering programmed logic circuitry. A benchmark database may store each said benchmark.

According to certain other exemplary embodiments, a computer-implemented method for aligning the interests of a principal and an agent serving the principal is provided. Information about a good and/or service for sale by each said vendor may be gathering from a plurality of vendors. A benchmark for each good and/or service based at least on the gathered product information may be calculated. Each said benchmark may be stored in a benchmark database.

According to still other exemplary embodiments, a computer-implemented method for aligning the interests of a principal and an agent serving the principal is provided. A benchmark for each purchasable good and/or service in a plurality of purchasable goods and/or services may be calculated. Information about a good and/or service to be purchased may be compared to a relevant benchmark. The agent may be rewarded based on the result of the comparing step.

It will be appreciated that these aspects, features, and embodiments may be combined in various combinations to realize yet further exemplary embodiments.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a conceptualized view of an exemplary task that helps to demonstrate the nature and character of the principal-agent problem;

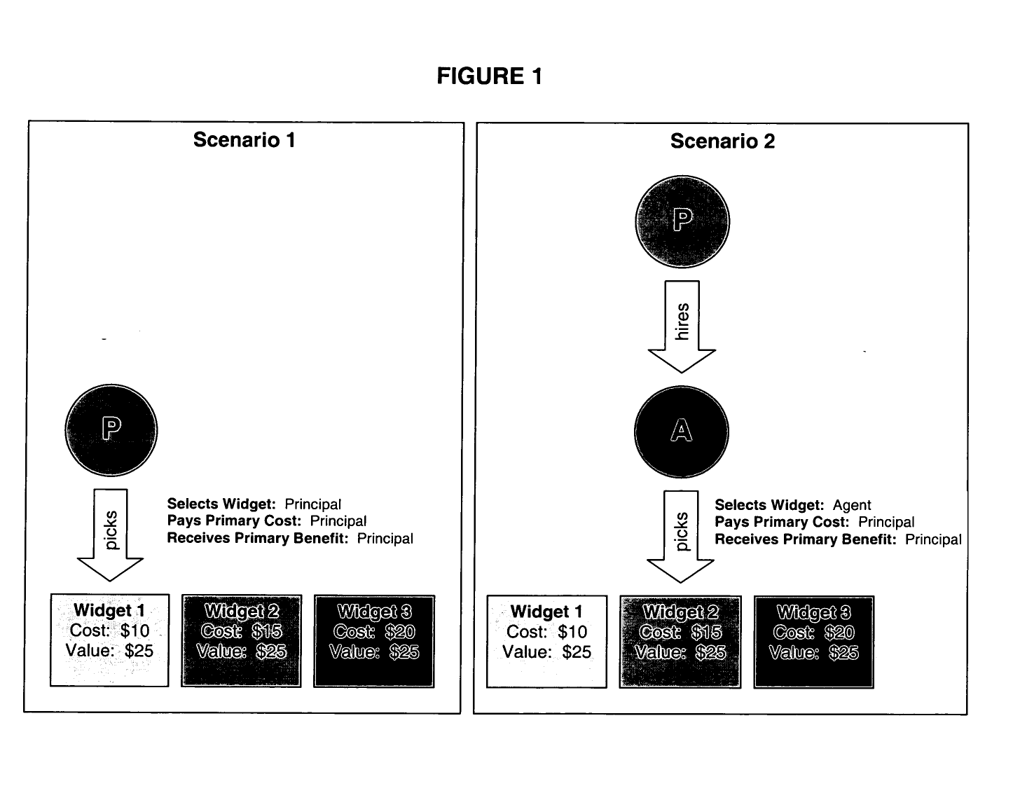

FIG. 2 is a conceptualized view that helps to demonstrate the nature and character of a benchmark-driven incentive scheme in accordance with certain exemplary embodiments;

FIG. 3 is an illustrative block diagram of a system for implementing a benchmark-driven incentive scheme in accordance with certain exemplary embodiments;

FIG. 4 is an illustrative flowchart illustrating a process for calculating a benchmark in accordance with certain exemplary embodiments; and,

FIG. 5 is an illustrative flowchart illustrating a process for implementing a benchmark-driven incentive scheme in accordance with certain exemplary embodiments.

### DETAILED DESCRIPTION

Certain exemplary embodiments relate to techniques for incentivizing agent-based decision-making by, for example, encouraging agents to become “true agents” of their principals by rewarding or penalizing the agents for exceeding or falling below benchmarks for specific transactions set by, or on behalf of, the principals. In particular, by setting a threshold benchmark and sharing the value of transactions that outperform the benchmark, a principal may encourage an agent to take a particular decision more aligned with its own interests. Although certain exemplary embodiments are described herein with reference to the actions, preferences, etc. of a “principal” and an “agent,” it will be appreciated that the present invention is not limited only to the strict legal definitions of the same.

### 1. Introduction to Exemplary Techniques

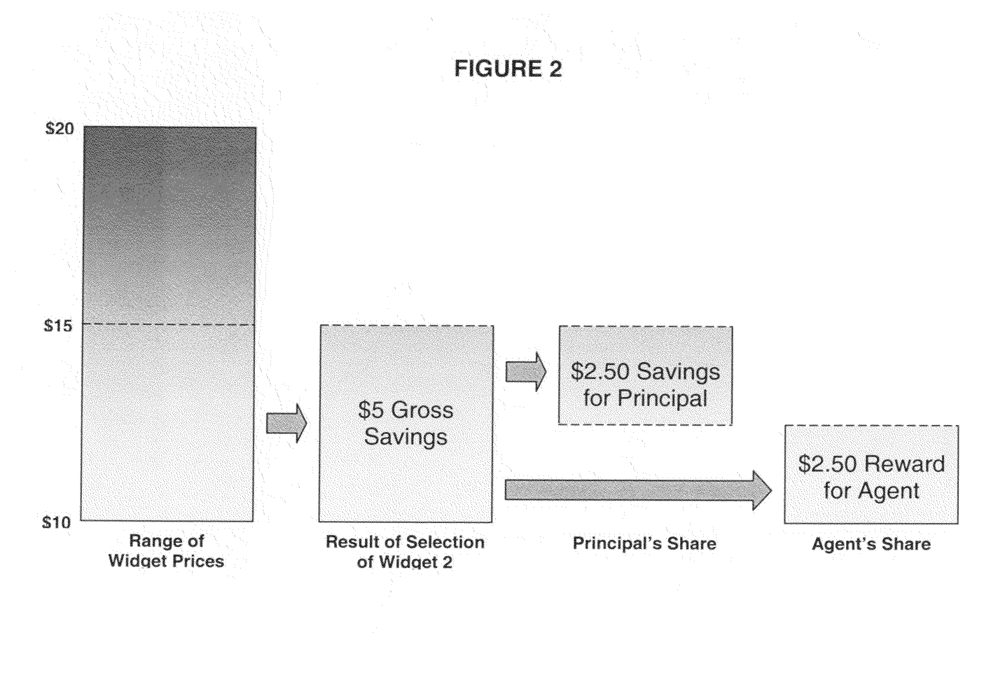

Returning to the above example scenarios and with further reference to FIG. 2, the nature and character of a benchmark-driven incentive scheme in accordance with certain exemplary embodiments will now be explained more fully. In the example shown in FIG. 2, the benchmark is set to $15, which is the average widget price and is represented by the dashed line. The purchase of any widget below the benchmark will result in a savings for the principal. By splitting the difference between the benchmark and the price paid, the agent is more likely to choose a lower-priced good. For example, purchasing widget 2 represents a total savings of, and beats the benchmark by, $5, at least from the principal's perspective. This savings may be shared by the principal and the agent, for example, as a reward for the agent for “beating the benchmark.”

As shown in greater detail in Tables 3a and 3b, the principal and agent now prefer the same option. Accordingly, after the principal hires the agent to choose a widget, when the principal promises half of the savings below the average widget price the agent will select the widget that the principal would have selected had the principal itself made the selection.

TABLE 3a

| | Benefits for Principal | Costs for Principal | Net |
|---|---|---|---|
| W1 | Primary Benefit: | Primary Cost: $10 direct cost | $25.00 |
| | $25 in value | | |
| | | Secondary Cost: $2.50 | −12.50 |
| | | incentive | $12.50 |
| W2 | Primary Benefit: | Primary Cost: $15 direct cost | $25.00 |
| | $25 in value | | |
| | | Secondary Cost: $0 incentive | −15.00 |
| | | | $10.00 |
| W3 | Primary Benefit: | Primary Cost: $20 direct cost | $25.00 |
| | $25 in value | | |
| | | Secondary Cost: $0 incentive | −20.00 |
| | | | $5.00 |

TABLE 3b

| | Benefits for Agent | Costs for Agent | Net |
|---|---|---|---|
| W1 | Program A: 5% of | Time/Energy: Most = $0.25 | $3.10 |
| | purchase = $0.50 | | |
| | Cash Back: 1% cash | Convenience: Least = $0.25 | −.50 |
| | back = $0.10 | | |
| | Incentive for beating | | |
| | benchmark = $2.50 | | $2.60 |
| W2 | Program B: 5% of | Time/Energy: Least = $0.10 | $1.65 |
| | purchase = $1.50 | | |
| | Cash Back: 1% cash | Convenience: Most = $0.10 | −.20 |
| | back = $0.15 | | $1.45 |
| W3 | Program A: 5% of | Time/Energy: Most = $0.25 | $1.20 |
| | purchase = $1 | | |
| | Cash Back: 1% cash | Convenience: Most = $0.10 | −.35 |
| | back = $0.20 | | $0.85 |

It will be appreciated that this scenario is given by way of example and without limitation. Numerous modifications are possible, including, for example, factoring in additional and/or alternative costs and/or benefits to the principal and/or agent, computing the benchmark in a way other than using average price, splitting the benefit in a way other than equal distribution between the principal and agent, and benefit without penalization, etc. Certain alternative arrangements are further specified below, but they should not be interpreted as being limiting the present invention.

### 2. Exemplary Systems for an Illustrative Benchmark-Driven Incentive Scheme

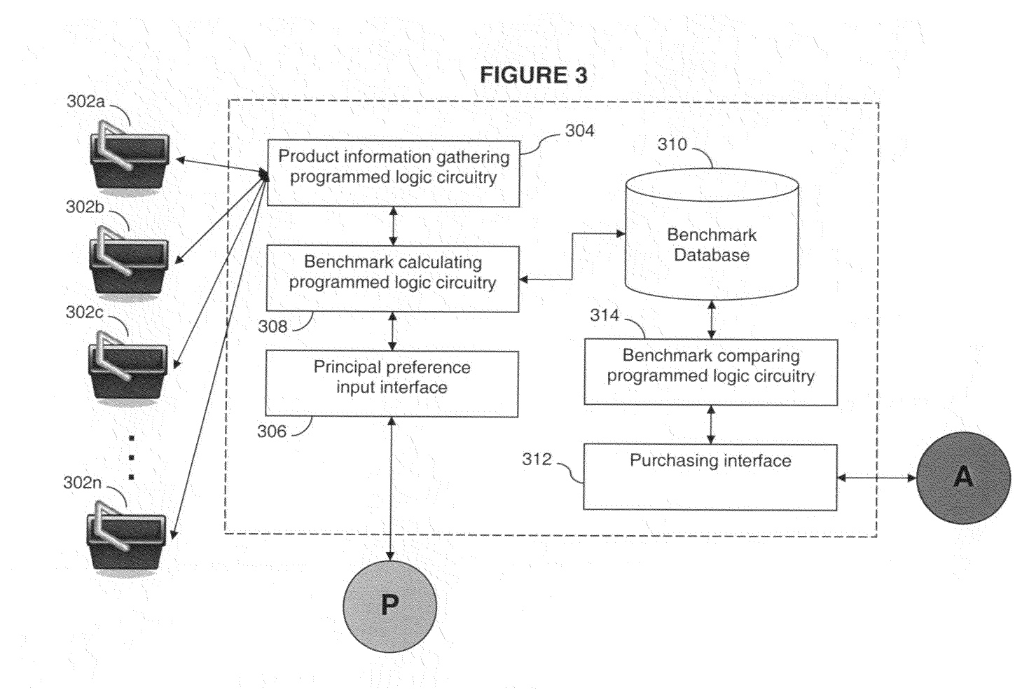

FIG. 3 is an illustrative block diagram of a system for implementing a benchmark-driven incentive scheme in accordance with certain exemplary embodiments. In FIG. 3, product data is gathered from a plurality of vendors 302a-n by product information gathering programmed logic circuitry 304. The product information gathered may include, for example, price, quantity, warranty, time to delivery, reviews, and/or any other information that might be useful to a prospective purchaser. The principal P may enter preference information via principal preference input interface 306. The preference information may include information such as, for example, certain preferred companies, products, providers, and/or the like. It also may specify preferences for longer warranties, more highly rated products, etc. Such factors also may include, for example, strength, robustness, longevity, quality, etc.

Based at least on the information from the product information gathering programmed logic circuitry 304 and/or the principal preference input interface 306, benchmark calculating programmed logic circuitry 308 may calculate a benchmark for a particular product, good, or service. The benchmark may be calculated by, for example, taking a simple average of all of the prices, by calculating a weighted average based on the principal's preferences, taking the median value, etc. A time element also may be introduced such that the benchmark takes into account, for example, the price for a product, service, etc. over time a predetermined amount of time. Trends in pricing thus also may be taken into consideration. The benchmark also may take into account the historical prices (e.g., prices paid by one or more employees of a company or companies in the last day, week, month, three months, year, etc.) paid by the agent or by a group of agents. After a benchmark for a particular product, service, etc. is calculated, it may be stored in the benchmark database 310 with other benchmark data (e.g., a unique identifier of the good, service, etc.; historical product information; historical benchmark information; etc.).

An agent A may initiate a purchase through a purchasing interface 312. Benchmark comparing programmed logic circuitry 314 may compare the information about the good and/or service to be purchased entered by the agent A to benchmark information stored in the benchmark database 310. The purchasing interface 312 may inform the agent A of the relevant benchmark and the agent's performance relative to the relevant benchmark. Based on this information, the agent A may consummate the purchase or continue to search for a better offer in an attempt to beat the benchmark (and thus earn a reward and/or avoid a penalty, as described in greater detail below).

Once a purchase ultimately is consummated, the agent A may be rewarded (or penalized) based on the performance relative to the benchmark. For example, the amount of savings relative to the benchmark may be split in some way between the principal and agent (e.g., according to a percentage), the agent may accrue principal-specific rewards, etc. If money is to be distributed to the agent, the system may do so automatically (e.g., via direct deposit, indication on a payroll form, etc.). Alternatively, such information may be recorded and/or reported to the principal to later reimburse the agent, as appropriate. Regardless of whether the agent beats the benchmark, purchasing information may be stored for later auditing by or on behalf of the principal.

It will be appreciated that the interfaces described herein may be for example, computer-implemented, telephone-based, or otherwise accessible interfaces. For example, in certain exemplary embodiments, the principal preference input interface 306 and/or the purchasing interface 312 may be implemented as webpages accessible over a computer-mediated network. It also will be appreciated that as used herein, the term programmed logic circuitry is intended to be broad enough to encompass any suitable combination of hardware, software, and/or the like.

### 3. Exemplary Methods for an Illustrative Benchmark-Driven Incentive Scheme

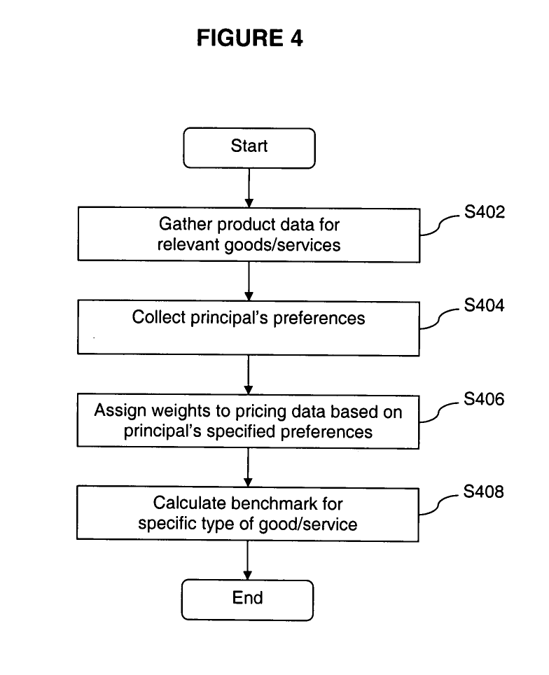

FIG. 4 is an illustrative flowchart illustrating a process for calculating a benchmark in accordance with certain exemplary embodiments. In FIG. 4, product data for certain goods and/or services is gathered in step S402, and the principal's preferences regarding certain goods and/or services are gathered in step S404. Certain exemplary types of product information that may be gathered are noted above, as are certain exemplary types of preference information.

In step S406, weights may be assigned to the pricing data based on, for example, the principal's specified preferences. For example, a principal preferring to do business with a key partner may attach a greater value to prolonging that relationship and therefore may introduce a weight to the basic product information gathered above. A benchmark for a specific type of good and/or service ultimately may be calculated in step S408, for example, in one or more of the ways mentioned above (e.g., average price, weighted average over time, median price, etc.).

It will be appreciated that some or all of the product, preference, and/or benchmark information may be stored in a benchmark database. The process of generating benchmarks may be performed when a user initiates a purchase request. That is, such benchmarks may be generated in whole or in part dynamically. For example, when a purchase request is initiated, the benchmark may be computed based on pre-retrieved information, information may be retrieved when the purchase request is initiated and a benchmark calculated accordingly, and/or information may be refreshed periodically with or without user (e.g., principal and/or agent) initiation (e.g., the information may be updated at predetermined intervals, when a principal requests the database to be refreshed, when a purchase order is initiated, etc.). It also will be appreciated that the information may be gathered, maintained, and/or processed directly by the principal, one or more agents of the principal, and/or by a separate provider.

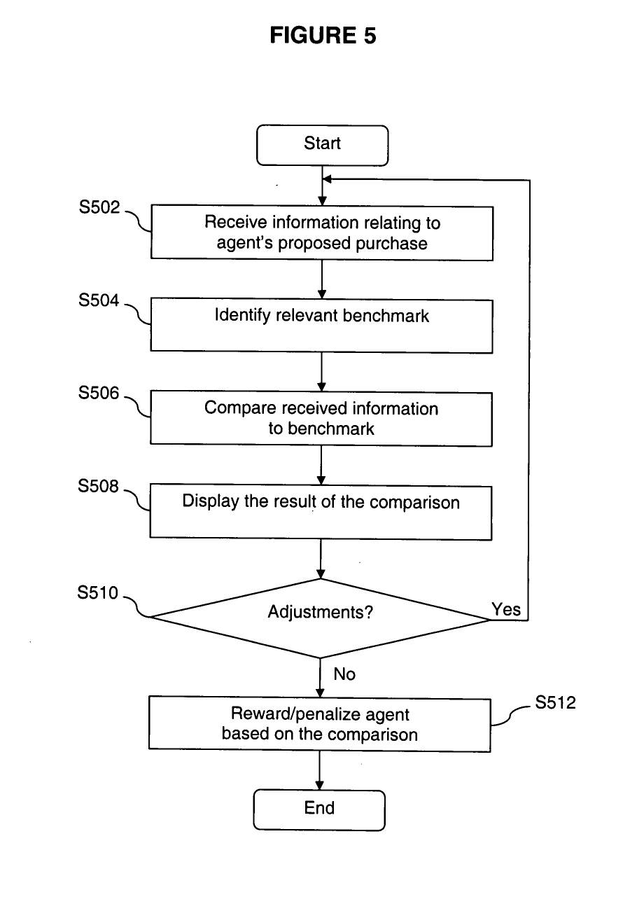

FIG. 5 is an illustrative flowchart illustrating a process for implementing a benchmark-driven incentive scheme in accordance with certain exemplary embodiments. In FIG. 5, information relating to the agent's proposed purchase is received. Such information may include, for example, the good and/or service to be purchased, the price, the vendor, etc. The relevant benchmark may be identified in step S504, and the received information may be compared to the benchmark in step S506. The result of the benchmark may be displayed or otherwise made known to the purchaser in step S508. If the purchaser decides to make adjustments based on, for example, the comparison, step S510 returns the process to step S502 for receiving revised information relating to the agent's proposed purchase. If there are no adjustments desired, the purchase may be consummated, and the agent may be rewarded (or penalized) based on the comparison in step S512.

### 4. Exemplary Implementations

Certain exemplary embodiments may have application to various fields of endeavor. For example, the following list identifies various incentives, transaction costs, and benchmarks when certain exemplary embodiments are applied to the purchasing of office supplies, business travel, and/or the sale of real estate. Of course, it will be appreciated that the same is provided by way of example and without limitation, in terms of the fields of endeavor, the incentives offered, transaction costs encountered, and rewards provided.
Purchase of Office Supplies
   Agent Incentives (excluding the benchmark incentive):
      Rewards program—for example, the Staples Rewards Program rewards the purchaser with 5% of the total amount spent
      Credit card cash back program—for example, American Express Membership Rewards provide 1% cash back
   Agent Transaction Costs:
      Time spent searching for best prices—for example, scouring the Internet, catalogs, and/or advertisements for the best price, etc.
      Time spent retrieving the option at the best price—for example, driving to the location, initiating a catalog and/or telephone order, purchasing over the Internet, etc.
   Beat the Benchmark Incentive: for example, a percent of the savings below the average cost of the office supplies may be awarded such that the employee receives a reward for spending less than the average price during a given timeframe
Business Travel
   Agent Incentives (excluding the benchmark incentive):
      Rewards Program—for example, frequent flyer programs
      Credit card cash back programs
      Convenience of departure and/or arrival times
      Convenience of departure and/or arrival airports
   Agent Transaction Costs:
      Time spent searching for the best prices
      Planning in advance to secure less expensive flights
   Beat the Benchmark Incentive: for example, a percent of the savings below the average cost of the ticket
Sale of Real Estate
   Agent Incentives (excluding the benchmark incentive): e.g., commission based on the sale price of the property
   Agent Transaction Costs: e.g., additional time and/or effort trying to get a higher sale price for the same or similar property
   Beat the Benchmark Incentive: e.g., a percentage of the additional value above the sale price for the same or similar property

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A system for aligning the interests of a principal and an agent serving the principal, comprising:
product information gathering programmed logic circuitry for gathering from a plurality of vendors information about a good and/or service for sale by each said vendor;
benchmark calculating programmed logic circuitry for calculating a benchmark for each good and/or service based at least on the information gathered by the product information gathering programmed logic circuitry; and, a benchmark database for storing each said benchmark.

2. The system of claim 1, further comprising:
a purchasing interface allowing an agent to input prospective purchase information for a good and/or service to be purchased; and,
benchmark comparing programmed logic circuitry for identifying and comparing a relevant benchmark to the prospective purchase information.

3. The system of claim 1, further comprising a principal preference input interface for receiving from the principal at least one preference associated with the purchase of goods and/or services.

4. The system of claim 1, wherein the product information gathering programmed logic circuitry gathers at least price information from each said vendor for each said product and/or service.

5. The system of claim 4, wherein the benchmark calculating programmed logic circuitry calculates the benchmark by averaging the price information.

6. The system of claim 3, wherein the benchmark calculating programmed logic circuitry is configured to weight the information about the goods and/or services based at least in part on the at least one preference.

7. The system of claim 1, wherein the benchmark database is maintained by a third party.

8. The system of claim 1, wherein the benchmark database is updated at predetermined time intervals.

9. The system of claim 2, wherein the benchmark database is updated when the agent initiates a purchase via the purchasing interface.

10. The system of claim 2, wherein the benchmark comparing programmed logic circuitry calculates a reward based on the comparison between the relevant benchmark and the prospective purchase information.

11. The system of claim 10, wherein the reward is shared between the agent and the principal based on at least one predetermined criterion.

12. A computer-implemented method for aligning the interests of a principal and an agent serving the principal, the method comprising:
gathering from a plurality of vendors information about a good and/or service for sale by each said vendor;
calculating a benchmark for each good and/or service based at least on the gathered product information; and,
storing each said benchmark a benchmark database.

13. The method of claim 12, further comprising:
receiving from an agent information relating to a prospective purchase of a good and/or service; and,
identifying a relevant benchmark for the good and/or service to be purchased; and,
comparing the relevant benchmark to the prospective purchase information.

14. The method of claim 12, further comprising receiving from the principal at least one preference associated with the purchase of goods and/or services.

15. The method of claim 12, wherein the gathering step gathers at least price information from each said vendor for each said product and/or service.

16. The method of claim 14, further comprising during the benchmark calculating step, weighting the information about the goods and/or services based at least in part on the at least one preference.

17. The method of claim 12, further comprising updating the benchmark database at a predetermined interval and/or event.

18. The method of claim 13, further comprising calculating a reward based on the comparison between the relevant benchmark and the prospective purchase information.

19. The method of claim 18, further comprising distributing the reward to the agent and the principal.

20. A computer-implemented method for aligning the interests of a principal and an agent serving the principal, the method comprising:
calculating a benchmark for each purchasable good and/or service in a plurality of purchasable goods and/or services;
comparing information about a good and/or service to be purchased to a relevant benchmark; and,
rewarding the agent based on the result of the comparing step.
